(19) United States
(12) Patent Application Publication
(10) Pub. No.: US 2023/0280678 A1
(43) Pub. Date: Sep. 7, 2023

(54) IMAGE FORMING APPARATUS

(71) Applicant: Hitoshi Yamamoto, Kanagawa (JP)

(72) Inventor: Hitoshi Yamamoto, Kanagawa (JP)

(73) Assignee: Ricoh Company, Ltd., Tokyo (JP)

(21) Appl. No.: 18/116,208

(22) Filed: Mar. 1, 2023

(30) Foreign Application Priority Data
Mar. 2, 2022 (JP) 2022-031850
Nov. 30, 2022 (JP) 2022-191461

(51) Int. Cl. G03G 15/16; G03G 21/00

(52) U.S. Cl. CPC G03G 15/16; G03G 21/0011

(57) ABSTRACT

An image forming apparatus includes a photoconductor; a charger, an exposure device, a developing device, a transferor, a cleaner, a belt resistance sensing device, and a transfer bias applier. The charger charges a surface of the photoconductor with a charge of a single polarity. The exposure device irradiates the surface of the photoconductor with light after charging. The developing device supplies a developer to the surface of the photoconductor. The transferor transfers an image developed by the developing device, from the surface of the photoconductor onto an intermediate transfer belt. The cleaner cleans the developer remaining on the surface of the photoconductor after an image transfer by the transferor. The sensing device is provided for the transferor, to detect a resistance value from a current value flowing during application of a transfer bias. The bias applier controls, according to the resistance value detected, the transfer bias applied to the transferor.

### CROSS-REFERENCE TO RELATED APPLICATIONS

This patent application is based on and claims priority pursuant to 35 U.S.C. § 119(a) to Japanese Patent Application Nos. 2022-031850, filed on Mar. 2, 2022, and 2022-191461, filed on Nov. 30, 2022, in the Japan Patent Office, the entire disclosure of each of which is hereby incorporated by reference herein.

### BACKGROUND

### Technical Field

Embodiments of the present disclosure relate to an image forming apparatus.

### Related Art

In an electrophotographic image forming apparatus, a residual potential exists on a latent image bearer after transfer processing. A technique using an electricity removal means, such as an electricity removal lamp, to remove such a residual potential is already known. On the other hand, a method for removing the residual potential on the latent image bearer without using an electricity removal lamp or the like is also being studied, and, for example, a technique for removing electricity by a transfer bias is also known.

However, a disadvantage is known that in a case of removing electricity using a transfer bias, even if the voltage applied to a transfer belt is constant, the unevenness of the resistance of the transfer belt itself causes the excessive or insufficient amount of the electricity removal, and thus a residual potential generates a residual image.

In order to solve such a problem, a method for restricting the unevenness of the resistance value of the transfer belt is also considered, but it is difficult to inclusively solve a fall in the productivity and an increase in the cost due to the yield deterioration.

### SUMMARY

According to an embodiment of the present disclosure, an image forming apparatus includes a photoconductor; a charger, an exposure device, a developing device, a transferor, a cleaner, a belt resistance sensing device, and a transfer bias applier. The charger charges a surface of the photoconductor with a charge of a single polarity. The exposure device irradiates the surface of the photoconductor with light after charging by the charger to form an electrostatic latent image. The developing device supplies a developer to the surface of the photoconductor. The transferor transfers an image developed by the developing device, from the surface of the photoconductor onto an intermediate transfer belt. The cleaner cleans the developer remaining on the surface of the photoconductor after an image transfer by the transferor. The belt resistance sensing device is provided for the transferor and detects a resistance value from a current value flowing during application of a transfer bias. The transfer bias applier controls, according to the resistance value detected by the belt resistance sensing device, the transfer bias applied to the transferor.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view illustrating an example of a configuration of an image forming apparatus according to an embodiment of the present disclosure;

FIG. 2 is a schematic view illustrating an example of a configuration of a process cartridge of the image forming apparatus, according to an embodiment of the present disclosure;

FIG. 3 is a graph illustrating a comparative example of a case where a transition of a surface potential of a transfer belt in processes results in a negative residual image;

FIG. 4 is a graph illustrating a comparative example of a case where a transition of a surface potential of the transfer belt in processes results in a positive residual image;

FIG. 5 is a graph illustrating an example of a transition of a surface potential of the transfer belt in processes according to according to an embodiment of the present disclosure;

FIG. 6 is a graph illustrating an example of a transition of a surface potential of the transfer belt in processes according to according to an embodiment of the present disclosure;

FIG. 7 is a graph illustrating an example of the relationship between post-transfer potentials and generated residual images;

FIG. 8 is a graph illustrating an example of the relationship between post-transfer potentials and transfer biases;

FIG. 9 is a graph illustrating an example of the relationship between post-transfer potentials and photoconductor film thicknesses;

FIG. 10 is a flowchart illustrating an example of an operation of measuring a transfer belt resistance according to the present disclosure;

FIG. 11 is a schematic view illustrating an example of measurement of the transfer belt resistance in FIG. 10;

FIG. 12 is a graph illustrating an example of measurement results of belt resistance values;

FIG. 13 is a graph illustrating an example of the relationship between photoconductor film thicknesses and running distances; and

FIG. 14 is a graph illustrating an example of the relationship between post-charging potentials and transfer biases.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

Embodiments according to the present disclosure are sequentially described with reference to the drawings. In the description of the embodiments below, components having the same function and configuration are appended with the same reference codes, and redundant descriptions thereof may be omitted. Components in the drawings may be partially omitted or simplified to facilitate understanding of the configurations.

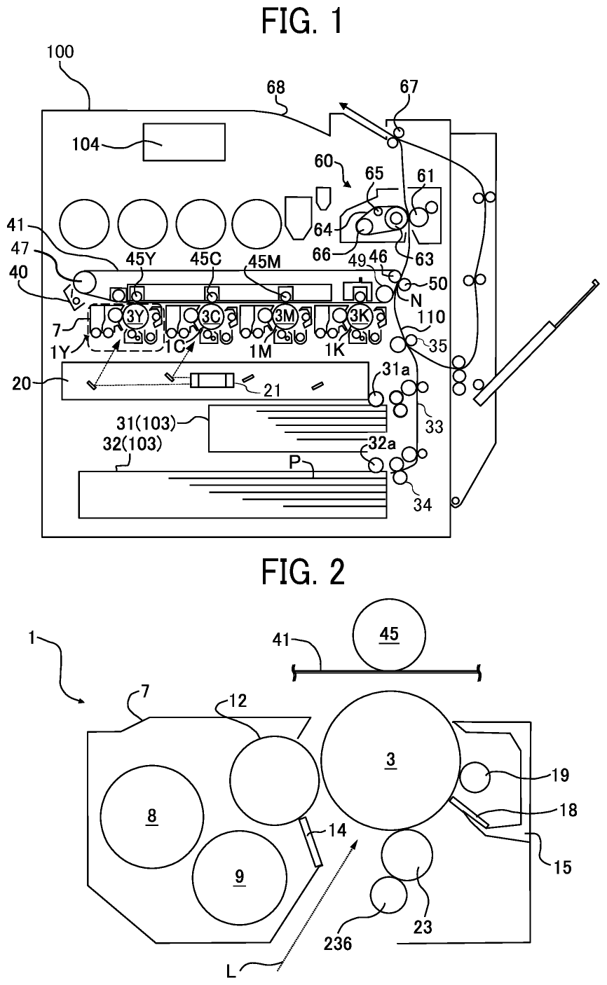

FIG. 1 illustrates an image forming apparatus to which an embodiment of the present disclosure is applied. FIG. 1 is a schematic view illustrating an embodiment of an electrophotographic color printer (hereinafter referred to as a “printer”) as an image forming apparatus according to the present disclosure. An image forming apparatus 100 according to the present disclosure is not limited to a printer, and may be a single copier or a single facsimile, or a multifunction peripheral having functions of at least two or more of a printer, a copier, a facsimile, a scanner, and the like.

As illustrated in FIG. 1, the image forming apparatus 100 includes four process cartridges 1Y, 1M, 1C, and 1K for generating toner images of yellow, magenta, cyan, and black (hereinafter referred to as Y, M, C, and K).

The process cartridges 1Y, 1M, 1C, and 1K use, respectively, Y, M, C, and K toners different in color as an image forming substance, but are similar in configuration except the toners. The process cartridges 1Y, 1M, 1C, and 1K are each replaced at the end of the service life.

The image forming apparatus 100 also includes a sheet feeder 103, a controller 104, an optical writing unit 20, a plurality of photoconductors 3Y, 3M, 3C, and 3K corresponding to the respective Y, M, C, and K colors, and an intermediate transfer belt 41, which is an intermediate transfer member. The photoconductors 3Y, 3M, 3C, and 3K are collectively referred to as the photoconductors 3. Similarly, the process cartridges 1Y, 1M, 1C, and 1K are also referred to as the process cartridges 1.

The image forming apparatus 100 also includes a fixing unit 60 that fixes, as an image, a toner image on a sheet P, and a sheet ejection roller 67 that is provided at the rearmost end of a conveyance path 110 including rollers and the like for conveying a sheet P, and ejects a sheet P to a sheet ejection tray 68.

In the description of the present embodiment, only a case where the image forming apparatus 100 operates as an electrophotographic full-color image forming apparatus that reads image information and forms an image on a surface of a sheet P will be described, but the image forming apparatus 100 is not limited to such a configuration. For example, the image forming apparatus 100 may have a configuration in which an image sent from another terminal is formed on a surface of a sheet P, and the present disclosure is not limited to a specific image forming method.

In the image forming apparatus 100, the sheet feeder 103 includes sheet feeding trays 31 and 32 in which sheets P are stacked and kept, and sheet feeding rollers 31a and 32a for taking out a sheet P from the sheet feeding trays 31 and 32.

From the sheet feeder 103, for example, the sheet feeding roller 32a sends out a sheet P as a recording material. The sent-out sheet P is conveyed through a sheet feeding path 33 to a pair of registration rollers 35 by a pair of conveyance rollers 34. The pair of registration rollers 35 sends the sheet P into a secondary transfer nip at a timing when a toner image is sent into the secondary transfer nip. Then the toner image on the intermediate transfer belt 41 is secondarily transferred to the sheet P by a secondary transfer bias applied to the secondary transfer nip.

The optical writing unit 20 is a light irradiation device for forming images, as latent images, as electrophotography, on the photoconductors 3, and irradiates the photoconductors 3 of the process cartridges 1 with a laser beam L on the basis of image information. In FIG. 1, as a general example of a configuration of the optical writing unit 20, a configuration is illustrated in which a laser beam L emitted from a light source is emitted to the photoconductors 3 via a plurality of lenses and mirrors while being deflected by a polygon mirror 21. However, instead of a polygon scanning scheme with such a configuration, optical writing means having various configurations, such as a light emitting diode (LED) array scheme, may be used.

The latent images on the photoconductors 3 are developed as toner images by adhesion of the toners, and then transferred as a toner image to a sheet P via the intermediate transfer belt 41.

The toner image transferred onto the sheet P receives heat and pressure in the fixing unit 60 to be fixed as an image, and is ejected by the sheet ejection roller 67.

The configuration except the sheet feeder 103, the controller 104, the optical writing unit 20, the photoconductors 3, the intermediate transfer belt 41, the fixing unit 60, the sheet ejection roller 67, the sheet ejection tray 68, and the like has a configuration as a general image forming apparatus, and the description thereof will be appropriately omitted.

In the drawing, arranged over the process cartridges 1Y, 1M, 1C, and 1K is an intermediate transfer unit that makes the intermediate transfer belt 41, which is an intermediate transfer member, move like an endless belt while the intermediate transfer belt 41 is hung and stretched. The intermediate transfer unit includes, in addition to the intermediate transfer belt 41, four primary transfer bias rollers 45Y, 45M, 45C, and 45K, a cleaning device 40, and the like.

The intermediate transfer unit also includes a secondary transfer backup roller 46, a cleaning backup roller 47, a tension roller 49, and the like.

While the intermediate transfer belt 41 is hung on and stretched by the plurality of rollers, the intermediate transfer belt 41 is moved like an endless belt counterclockwise in the drawing by rotational driving of at least one of the rollers.

The primary transfer bias rollers 45Y, 45M, 45C, and 45K sandwich the intermediate transfer belt 41 that moves like an endless belt, between the primary transfer bias rollers 45Y, 45M, 45C, and 45K and the respective photoconductors 3Y, 3M, 3C, and 3K, to form respective primary transfer nips.

These are a scheme for applying transfer biases having a (for example, positive) polarity opposite to the polarity of the toners, to the back surface (inner peripheral surface) of the intermediate transfer belt 41. That is, a primary transfer bias is applied to each of the primary transfer bias rollers 45Y, 45M, 45C, and 45K by a transfer bias power supply 72. As a result, transfer electric fields are formed between toner images of the colors of Y, M, C, and K on the photoconductors 3, and the primary transfer bias rollers 45Y, 45M, 45C, and 45K, and the primary transfer bias rollers 45Y, 45M, 45C, and 45K function as transferors.

For example, a Y toner image on the surface of the yellow photoconductor 3Y enters the yellow primary transfer nip, with the rotation of the yellow photoconductor 3Y. Then the Y toner image is primarily transferred from the photoconductor 3Y onto the intermediate transfer belt 41 by the action of the transfer electric field and the nip pressure. Then the intermediate transfer belt 41 on which the Y toner image has been primarily transferred as described above sequentially passes through the M, C, and K primary transfer nips. Then M, C, and K toner images on the photoconductors 3M, 3C, and 3K are sequentially superimposed and primarily transferred onto the Y toner image by similar action. Due to the primary transfer of the superimposition, a toner image in which the four colors are superimposed (hereinafter referred to as a four-color toner image) is formed on the intermediate transfer belt 41. As primary transfer members, instead of the primary transfer bias rollers 45Y, 45M, 45C, and 45K, transfer chargers, transfer brushes, or the like may be adopted as transferors.

All the rollers except the primary transfer bias rollers 45Y, 45M, 45C, and 45K are electrically grounded.

FIG. 2 is a view illustrating an internal structure of the process cartridge 1K. With respect to each of the colors of C, M, and Y, the configuration is similar. Therefore, the notation of K indicating the color is omitted here.

The photoconductor 3 has a drum shape including an organic photoconductive layer on the surface of a drum base. The photoconductor 3 is rotationally driven in a clockwise direction in the drawing by a driving device.

Around the photoconductor 3, a cleaning brush 19 and a cleaning blade 18 that constitute a drum cleaning device 15 are arranged in clockwise order from the position of the primary transfer nip. Also arranged are a charging roller 23 serving as a charging member to which a charging bias is applied, and a cleaning brush roller 236 for tapping off toner from the charging roller 23. A developing device 7 is also provided on the clockwise downstream side of the charging roller 23.

The charging roller 23 is a charger that generates a discharge between the charging roller 23 and the photoconductor 3 while being in contact with or near the photoconductor 3, to uniformly charge the surface of the photoconductor 3. Instead of a scheme in which a charging member, such as the charging roller, is in contact with or near the photoconductor 3, a scheme in which a charging charger is used may be adopted. The surface of the photoconductor 3 uniformly charged by the charging roller 23 is optically scanned and exposed by a laser beam L emitted from the optical writing unit 20, or the like, and thus bears an electrostatic latent image for each color. The electrostatic latent image is developed by the developing device 7 using the corresponding color toner, and thus becomes a toner image of the corresponding color. The toner image on the photoconductor 3 is primarily transferred by the action of the primary transfer bias roller 45, to the surface (toner image bearing surface) of the intermediate transfer belt 41 including an endless belt member.

The drum cleaning device 15 is a cleaner that removes residual transfer toner adhering to the surface of the photoconductor 3 after a primary transfer step (the primary transfer nip). The drum cleaning device 15 includes the cleaning brush 19 that is rotationally driven, and the cleaning blade 18 having one supported end, and a free end that is in contact with the photoconductor 3. The drum cleaning device 15 scrapes residual transfer toner from the surface of the photoconductor 3 with the rotating cleaning brush 19, and scrapes down the residual transfer toner from the surface of the photoconductor 3 with the cleaning blade 18 to perform the cleaning.

Residual charges of the photoconductor 3 from which the residual transfer toner has been removed by the drum cleaning device 15 are removed by an electricity removal device. The surface of the photoconductor 3 is initialized by the electricity removal to become ready for the next image formation to become in a state in which the surface of the photoconductor 3 is ready to be uniformly charged by the charging roller 23, and is ready for writing of an electrostatic latent image with a laser beam L by the optical writing unit 20.

The developing device 7 develops the latent image using a two-component developer (hereinafter simply referred to as a developer) containing a magnetic carrier and a non-magnetic toner.

The developing device 7 is a developing unit including a stirring unit 8 that conveys the developer contained in the stirring unit 8 while stirring the developer, to supply the developer to a developing sleeve 12 that is tubular, a supply unit 9 that conveys the developer delivered from the stirring unit 8 while stirring the developer, to supply the developer to the developing sleeve 12 that is tubular, and the developing sleeve 12 serving as a developer bearer for transferring, to the photoconductor 3, the toner in the developer borne on the surface.

The developing sleeve 12 is a tubular object that faces the photoconductor 3K through an opening provided for the casing, and contains a magnet roller.

The developing device 7 includes a doctor blade 14 arranged such that the tip of the doctor blade 14 is close to the developing sleeve 12. The magnet roller inside the developing sleeve 12 has a plurality of magnetic poles sequentially aligning along a rotation direction of the developing sleeve 12 from a position facing the doctor blade 14. Each of these magnetic poles applies a magnetic force to the developer held on the developing sleeve 12 at a predetermined rotation-direction position. Due to such a configuration, the developer sent from the supply unit 9 is attracted to and borne on the surface of the developing sleeve 12, and a magnetic brush along lines of magnetic force is formed on the surface of the developing sleeve 12.

The magnetic brush is regulated to an appropriate layer thickness when passing through the position facing the doctor blade 14 with the rotation of the developing sleeve 12, and then conveyed to a development region facing the photoconductor 3.

Then a potential difference between a developing bias applied to the developing sleeve 12 and an electrostatic latent image of the photoconductor 3 transfers the toner onto the electrostatic latent image to contribute to the development.

As described above, the photoconductor 3 with the toner image formed on the surface by the development by the developing device 7 enters the K primary transfer nip with the rotation. In the primary transfer nip, the toner image (for example, a K toner image) on the photoconductor 3 is transferred to the intermediate transfer belt 41, which is a transfer member.

A secondary transfer roller 50 disposed outside the loop of the intermediate transfer belt 41 sandwiches the intermediate transfer belt 41 between the secondary transfer roller 50 and the secondary transfer backup roller 46 inside the loop, so that the secondary transfer roller 50 and the front surface of the intermediate transfer belt 41 form a secondary transfer nip N. A secondary transfer bias is applied to the secondary transfer backup roller 46. As a result, formed between the secondary transfer backup roller 46 and the intermediate transfer belt 41 is a secondary transfer electric field for electrostatically moving the toner having the negative polarity, from the secondary transfer backup roller 46 side toward the sheet P side.

The fixing unit 60 is disposed over the secondary transfer nip N. A sheet P to which a full-color toner image has been transferred is sent into the fixing unit 60.

The fixing unit 60 includes a pressure-applying roller 61, and a fixing belt 64 hung on and stretched by a fixing roller 63, a heating roller 66, and a tension roller 65. A fixing nip is formed at a location where the fixing belt 64 is in contact with the pressure-applying roller 61. The sent-into sheet P is sandwiched by the fixing nip where the pressure-applying roller 61 is in contact with the fixing belt 64 containing a heat source, so that the heating and the pressure application soften and fix the toner in the full-color toner image. The sheet P after the fixing is ejected to the sheet ejection tray 68 by the sheet ejection roller 67.

As described above, in an electrophotographic image forming apparatus, an image on a recording medium is obtained by developing an electrostatic latent image with a developer, and it is desirable that an electrostatic latent image formed on a photoconductor is completely removed for each formation. In reality, however, it is known that an unintended image is formed as a residual image due to residual potential remaining on the photoconductor.

As the residual image, there are two types: what is called a negative residual image and what is called a positive residual image, depending on the generation mechanism. At a time of recharging of the photoconductor in or after a second rotation, a phenomenon in which the potential of a portion that has not been exposed in a first rotation is higher than the potential of a portion that has been exposed in the first rotation is referred to as a negative residual image, and a phenomenon in which the potential of a portion that has been exposed in a first rotation is higher than the potential of a portion that has not been exposed in the first rotation is referred to as a positive residual image. Which of the negative residual image and the positive residual image is generated depends on an image formation process condition, and it is known that the negative residual image tends to be generated when a transfer bias is high, and the positive residual image tends to be generated when a transfer bias is low.

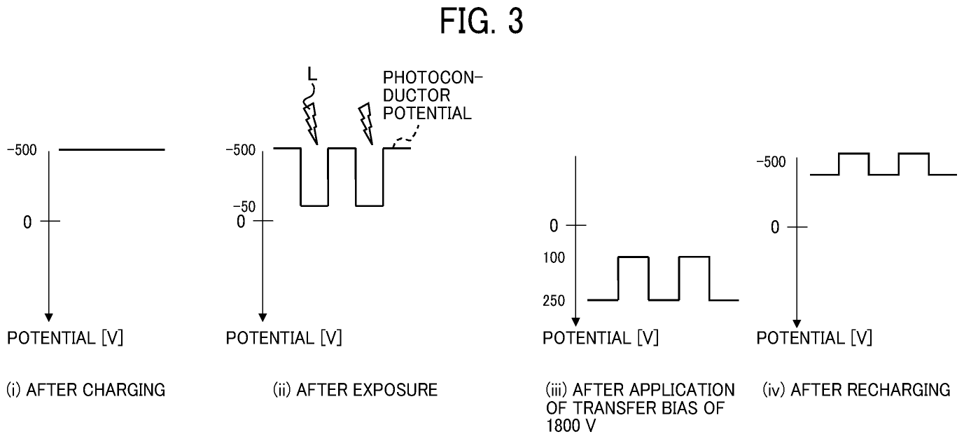

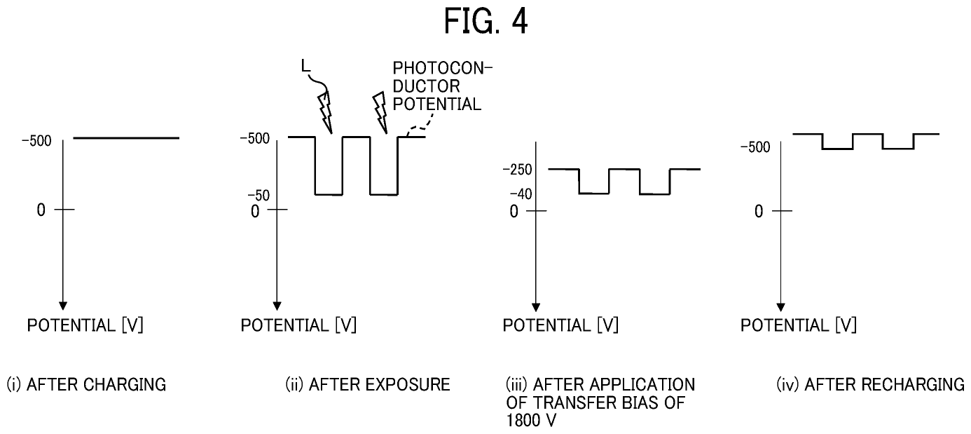

FIG. 3 illustrates a transition of a photoconductor surface potential during the generation of a negative residual image. FIG. 4 illustrates a transition of a photoconductor surface potential during the generation of a positive residual image.

The transitions of the photoconductor surface potentials will be described. First, with regard to FIG. 3, the photoconductor surface potential of the photoconductor in a first rotation is evenly charged, as illustrated in “(i) AFTER CHARGING”. Next, in a case where a latent image is formed on the surface by exposure to a laser beam L, in an exposed portion, positive charges are induced from the inside of the photoconductor, and neutralized by negative charges on the surface of the photoconductor, so that the potential becomes high (positive side), as illustrated in “(ii) AFTER EXPOSURE”.

Since the transfer bias is a positive voltage, the potential difference between a non-exposed portion and the transfer bias is larger than the potential difference between the exposed portion and the transfer bias, the current more easily flows through the non-exposed portion than the exposed portion during the transfer, and the amount of post-discharge after the transfer is also larger in the non-exposed portion than the exposed portion.

As a result, the non-exposed portion receives excessive electricity removal, and the photoconductor surface potential becomes high “(iii) AFTER APPLICATION OF TRANSFER BIAS OF 1800 V”. When still in the state illustrated in (iii), the photoconductor is uniformly recharged, a potential difference is generated between the non-exposed portion and the exposed portion, as illustrated in (iv), and in this case, a negative residual image is generated “(iv) AFTER RECHARGING”.

FIG. 4 illustrates a case where a photoconductor surface potential after a transfer does not receive sufficiently even electricity removal after the transfer, and an exposed portion maintains a potential higher than the potential of a non-exposed portion after the electricity removal (iii).

In such a case, as illustrated in (iv), a potential difference is generated between the non-exposed portion and the exposed portion, and a positive residual image is generated.

In order to solve such a disadvantage, the transfer bias from the intermediate transfer belt 41 is controlled such that the transfer bias is lowered in a case of the condition illustrated in FIG. 3 in which a negative residual image is likely to be generated, and the transfer bias is raised in a case of the condition illustrated in FIG. 4 in which a positive residual image is likely to be generated, to reduce the residual image.

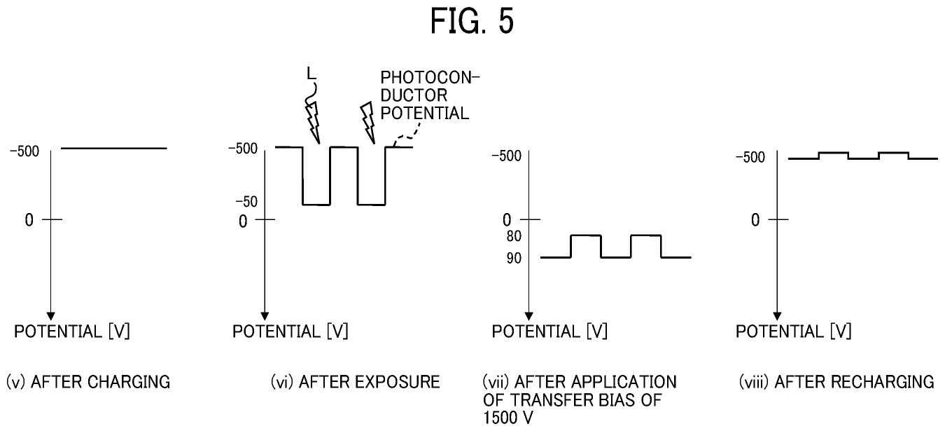

In FIG. 5, a transition of the photoconductor surface potential, from the state of (iii) illustrated in FIG. 3, in a case where a transfer bias of 1500 V is applied is illustrated as (vii). (v) and (vi) are states similar to (i) and (ii), and thus the description is omitted.

In (vii), the potential difference between a non-exposed portion and a transfer bias is also larger than the potential difference between an exposed portion and the transfer bias, the current more easily flows through the non-exposed portion than the exposed portion during the transfer, and the amount of post-discharge after the transfer is also larger in the non-exposed portion than the exposed portion. However, since the transfer bias applied at a positive potential is relatively low, the absolute value of a resulting residual potential decreases as well as electricity removal of the non-exposed portion that receives excessive electricity removal otherwise is restricted to low, and thus the potential difference between the exposed portion and the non-exposed portion varies in a direction in which the potential difference decreases.

Such a change reduces a difference in the photoconductor surface potential generated between the exposed portion and the non-exposed portion at a time of recharging, as illustrated in “(viii) AFTER RECHARGING”.

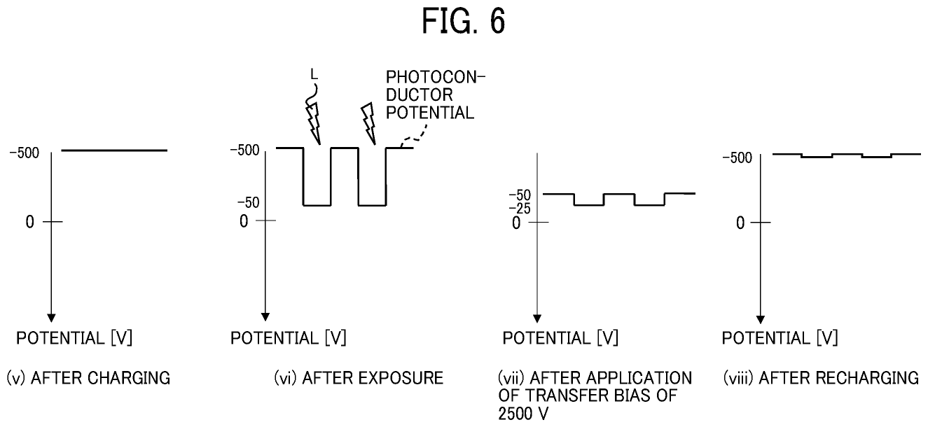

Next, in FIG. 6, a transition of the photoconductor surface potential, from the state of (iii) illustrated in FIG. 4, in a case where a transfer bias of 2500 V is applied is illustrated as (vii). (v) and (vi) are states similar to (i) and (ii), and thus the description is omitted. It has been already described that in the case of FIG. 4, a positive residual image is likely to be generated due to insufficient electricity removal.

In (vii), in order to solve this point, the photoconductor surface potential is measured with the transfer bias raised to 2500 V.

At this time, since the applied positive potential is larger than in the case of (iii), the potential difference between a non-exposed portion and the transfer bias is larger than the potential difference between an exposed portion and the transfer bias, a current more easily flows through the non-exposed portion than the exposed portion during the transfer, and the amount of post-discharge after the transfer is also larger in the non-exposed portion than the exposed portion. Therefore, since the non-exposed portion receives excessive electricity removal for the same reason as the reason described in FIG. 3, the potential difference generated between the non-exposed portion and the exposed portion makes a transition in a direction in which the potential difference decreases, as illustrated in (vii).

As a result, as shown in “(viii) AFTER RECHARGING”, the difference in the photoconductor surface potential between the non-exposed portion and the exposed portion that causes a positive residual image is suppressed.

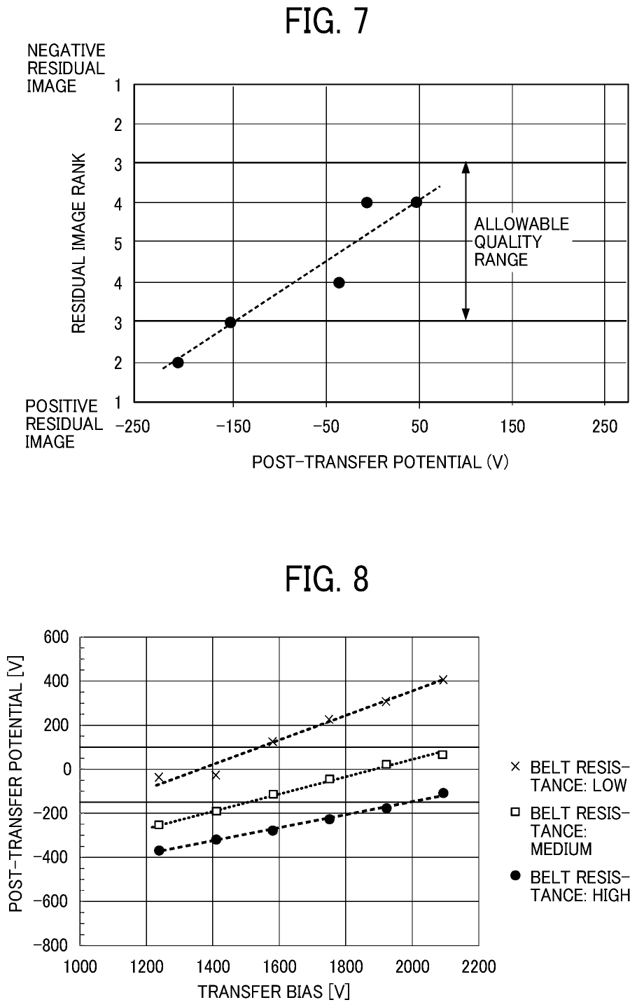

FIG. 7 illustrates a result of ranking and evaluation of residual image qualities for post-transfer potentials of the photoconductor. In the evaluation of FIG. 7, a case where the residual image quality was good and no residual image was generated is designated as rank 5, a case where the residual image quality was poor is designated as rank 1, the upper side of FIG. 7 is an increase in a negative residual image, and the lower side of FIG. 7 is an increase in a positive residual image, and the post-transfer potential was measured on the horizontal axis. As a standard of the image evaluation, ranks 3 and 4 are illustrated within an allowable quality range, as levels at which a residual image is generated but is not a disadvantage for the image.

As is clear from FIG. 7, as a negative value of the post-transfer potential increases, the generation of a positive residual image increases due to insufficient electricity removal, and on the other hand, as a positive value of the post-transfer potential increases, a negative image rank deteriorates due to excessive electricity removal.

Therefore, for the purpose of the restriction within a desired residual image quality, it is important to control the post-transfer potential within a certain range.

The inventor focused on the maintenance of the post-transfer potential, and investigated the relationship between a belt resistance value, which is the electric resistance value of the intermediate transfer belt 41, and a post-transfer photoconductor potential. As a result, it was found that a correlation as illustrated in FIG. 8 is generated between the belt resistance value (Ω) and a transfer bias, and the post-transfer potential.

In a case where the same transfer bias (V) is applied, as the belt resistance value is higher, the transfer current decreases and the electricity removal is more difficult, and the post-transfer potential falls. Therefore, in order to suppress a positive residual image that is likely to be generated, it is important to apply a transfer bias as high as possible. However, in a case where the belt resistance value is low, it is easy to perform the electricity removal, and thus the post-transfer potential is likely to be low, and a negative residual image is likely to be generated. Therefore, it is desirable to restrict the transfer bias to low.

From the above, it became clear that in order to restrict the absolute value of the post-transfer potential within the allowable quality range, as illustrated in FIG. 7, it is desirable to vary the transfer bias according to the belt resistance value R.

In addition, it has been found that for the purpose of the restriction within such an allowable quality range, it is effective to restrict the post-transfer potential illustrated in FIG. 8 within ±100 V.

The belt resistance value R is determined by the components and physical properties of the intermediate transfer belt 41, but also fluctuates depending on the thickness of the intermediate transfer belt 41 and also fluctuates depending on wear of the intermediate transfer belt 41, and the like. Therefore, there is a fear that restriction of the belt resistance value within a certain tolerance may also increase the cost and cause the yield deterioration.

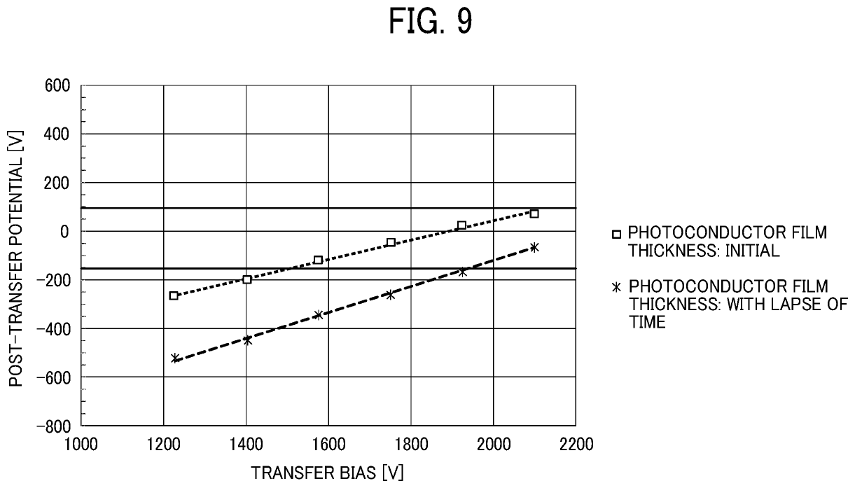

FIG. 9 illustrates a relationship between the primary transfer bias and the post-transfer photoconductor potential depending on the difference in the film thickness of the photoconductor 3.

Since the surface of the photoconductor is in a state where dielectric induces charges on the surface, C=εS/d in which the film thickness is d, and the relative permittivity is ε. From the capacitor formula Q=CV, V=Qd/εS. In a case of the same surface potential, the thicker the film thickness of the photoconductor is, the smaller the amount of the charges. Therefore, the thicker the film thickness is, even if a transfer current is the same, the more easily the influence is received, and the more easily electricity removal is received. That is, in a case where the photoconductor film is thick, it is desirable to restrict a transfer bias to low, as in a case of a low belt resistance value.

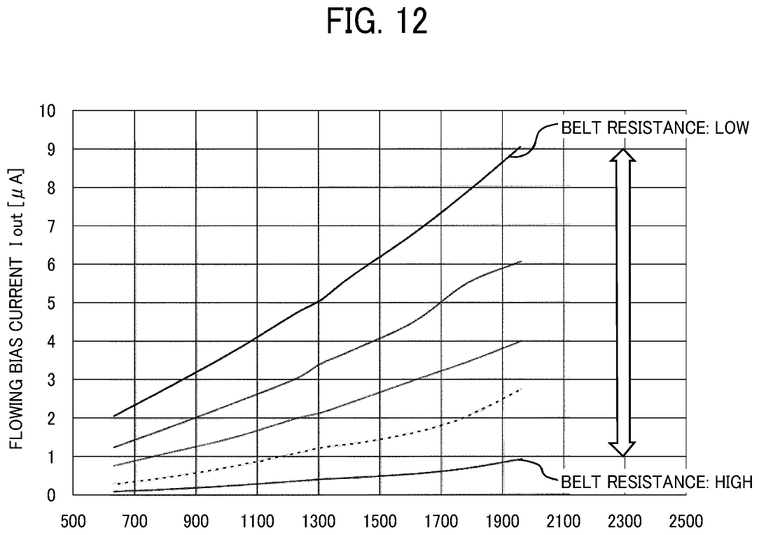

Since the photoconductor film thickness falls due to the variation with a lapse of time, it is preferable to add a fluctuation to the transfer bias depending on a time. However, as described later with reference to FIG. 12, it is known that the variation of the photoconductor film thickness with a lapse of time is substantially proportional to the running distance of the intermediate transfer belt 41.

From the above, it has become clear that, in order to restrict the absolute value of the post-transfer potential within the allowable quality range, as illustrated in FIG. 7, for the determination of a transfer bias, it is desirable to make the transfer bias fluctuate depending on the running distance of the intermediate transfer belt 41 in addition to the belt resistance value.

Therefore, in the present embodiment, in order to control the transfer bias, provided is a current sensing circuit 42, which is a belt resistance sensing device, for measuring the belt resistance value of the intermediate transfer belt 41.

The current sensing circuit 42 is coupled to at least one of the primary transfer bias rollers 45Y, 45M, 45C, and 45K, and senses the belt resistance value of the intermediate transfer belt 41 from a current value flowing when the at least one of the primary transfer bias rollers 45Y, 45M, 45C, and 45K applies the transfer bias.

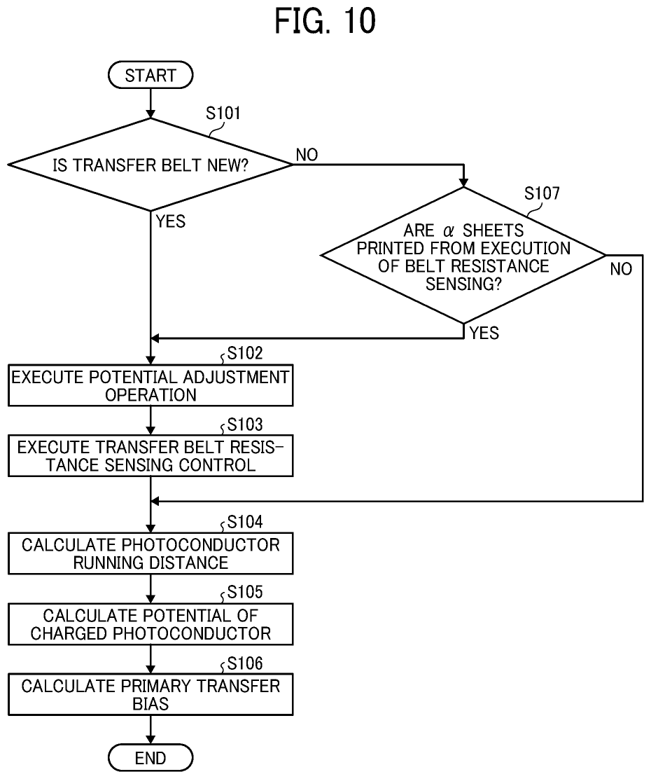

Alternatively, the image forming apparatus 100 calculates the primary transfer bias by a flowchart as illustrated in FIG. 10 when the intermediate transfer belt 41 is replaced or manufactured.

This point will be described in detail.

When the controller 104 determines that the primary transfer bias needs to be calculated, the controller 104 first checks whether or not the intermediate transfer belt 41 is new (step S101). Whether or not the intermediate transfer belt 41 is new may be checked by a known method in which an identification (ID) chip is provided for the intermediate transfer belt 41, or may be checked by a user operation at a time of the replacement. Alternatively, the check may be performed depending on the running distance from the replacement, and the technique is not particularly limited.

When in step S101, it is determined that the intermediate transfer belt 41 is new (Yes in step S101), the controller 104 executes a potential adjustment operation of the photoconductor 3 (step S102). In step S102, the surface potential of the photoconductor 3 is set to a predetermined value, for example, —500 V in the present embodiment, as illustrated in (i) of FIG. 3 or 4.

Next, in order to measure the resistance value of the intermediate transfer belt 41, the controller 104 measures a transfer current using the current sensing circuit 42 (step S103).

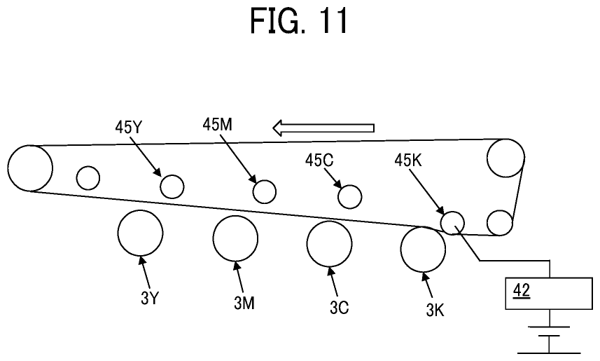

FIG. 11 illustrates a measurement example of the transfer belt resistance sensing control operation. In the present embodiment, in particular, only an example where the current sensing circuit 42 is coupled to the primary transfer bias roller 45K corresponding to black will be described, but a case where the current sensing circuit 42 is attached to the alternative primary transfer bias roller 45Y, 45M, or 45C is also similar. In a case of a monochrome image, only black moves. In a case of a color image, however, since the other photoconductors also operate, the running distance of the intermediate transfer belt 41 becomes long. Therefore, for at least the measurement of a transfer current at a time of the replacement with a new one, it is more preferable to measure the belt resistance value using the primary transfer bias roller 45K.

At this time, the current sensing circuit 42 measures the bias current that has flowed through the primary transfer bias roller 45K to detect the belt resistance value R that is the resistance value of the intermediate transfer belt 41.

FIG. 12 is a graph illustrating, with respect to a plurality of the intermediate transfer belts 41 measured in step S103, a bias current in a case where each transfer bias was applied, and a resulting belt resistance value.

In this way, in a case where the belt resistance value is high, the flowing bias current is restricted to low relative to the transfer bias, whereas in a case where the belt resistance value is low, the bias current tends to be large relative to the transfer bias. Therefore, bias current values at times of application of predetermined voltages to the primary transfer bias roller 45K are collected in, for example, a table, so that the belt resistance value measured in step S103 is classified into, for example, three patterns of high, medium, and low.

In the present embodiment, the belt resistance value R measured in step S103 is classified into, for example, three patterns of high, medium, and low. Specifically, the belt resistance value R is classified into, for example, a high belt resistance value (larger than 1.0×10^{10.5} Ω), a low belt resistance value (smaller than 1.0×10^{9.5} Ω), and a medium resistance value (1.0×10^{9.5} Ω<R<1.0×10^{10.5} Ω). The following processing is performed according to each classification of the belt resistance value.

The controller 104 stores the classification of the belt resistance values R and the intermediate transfer belt 41 in association with each other.

Next, the controller 104 calculates a photoconductor running distance correlating with the film thickness of the photoconductor 3 (step S104).

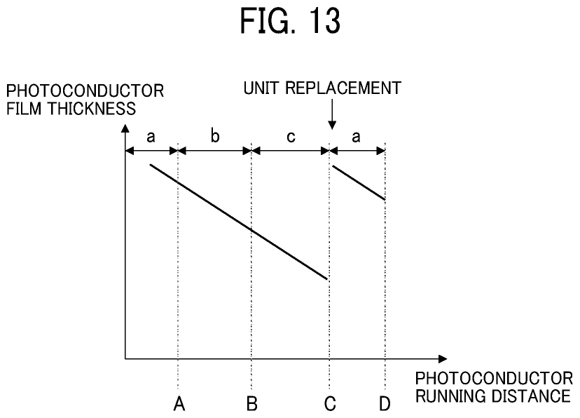

Specifically, from a known graph where the running distance of the photoconductor 3 is on the horizontal axis, and the photoconductor film thickness is on the vertical axis, as illustrated in FIG. 13, the photoconductor running distance is calculated from a driving time of a motor that drives the photoconductor 3 stored in the controller 104, and the photoconductor film thickness is estimated.

The controller 104 also measures the surface potential of the photoconductor 3 after the photoconductor 3 is charged by the charging roller 23 (step S105). The surface potential after such charging will also be described.

A case where the post-charging potential is low despite the same surface area indicates that since in the present embodiment, the photoconductor surface is negatively charged, the surface of the photoconductor 3 has a large amount of the charges. That is, it is said that for the same photoconductor 3, the higher the post-charging potential (the smaller the absolute value in the negative direction), the more easily the influence of the bias current is received, for a reason similar to the reason described for the influence of the photoconductor film thickness.

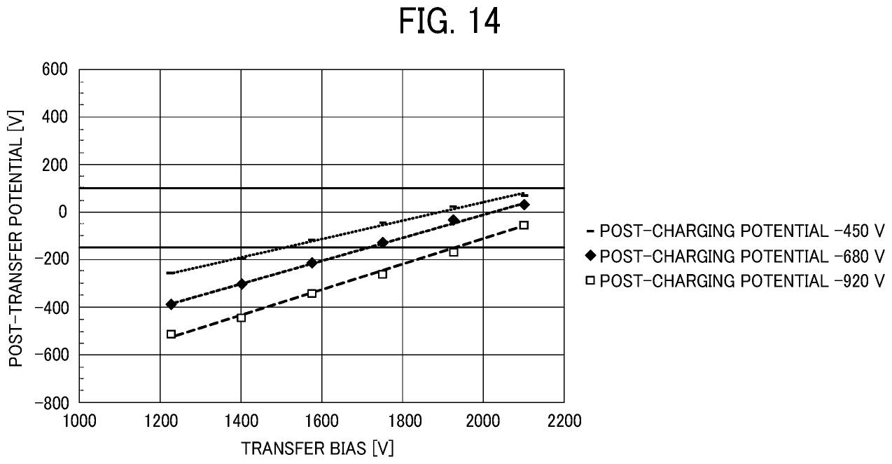

That is, when the post-charging potential is low, the transfer bias is made larger than at a time of the high post-charging potential, so that the influence of the bias current is restricted to restrict the generation of a residual image. Therefore, in step S105, the surface potential after charging before the exposure by the optical writing unit 20 is measured, so that the optimum transfer bias is selected as illustrated in FIG. 14.

The controller 104 calculates a primary transfer bias from the various parameters measured in steps S102 to S105 (step S106).

Specifically, the controller 104 determines a primary transfer bias from the predetermined table, on the basis of the belt resistance value R of the intermediate transfer belt 41, and the photoconductor film thickness d calculated from the running distance.

Specifically, as described in FIGS. 5 and 6, when the belt resistance value is high, electricity removal by the bias current does not sufficiently work, and a positive residual image is likely to be generated. Therefore, in the present embodiment, in a case where the belt resistance value measured by the current sensing circuit 42 is high, the controller 104 performs control to make the primary transfer bias large to increase the transfer bias.

In a case where the belt resistance value is low, the influence of electricity removal by the bias current is large, and a negative residual image is likely to be generated. Therefore, in a case where the belt resistance value is low, the controller 104 performs control to make the primary transfer bias small to decrease the transfer bias.

In the present embodiment, such a change reduces a difference in the photoconductor surface potential generated between an exposed portion and a non-exposed portion when the photoconductor is charged again, as illustrated as “(viii) AFTER RECHARGING”.

As described above, on the basis of a measurement result of the belt resistance value by step S103, the primary transfer bias is changed, so that the potential difference generated between a non-exposed portion and an exposed portion after the electricity removal makes a transition in a direction in which the potential difference decreases as compared with a case where a predetermined bias voltage is simply applied as the primary transfer bias.

Such a configuration removes the residual charges to suppress the generation of a residual image while the configuration prevents an increase in the size and cost of the apparatus due to an electricity removal member.

In the present embodiment, a voltage value applied to the primary transfer bias roller 45 using a transfer bias applier increases with an increase in the photoconductor running distance.

As described above, the reason is that the film thickness of the photoconductor 3 gradually decreases depending on the running distance of the photoconductor 3, and even if the potential is the same, the amount of charges appearing on the surface decreases, and the amount of voltage drop due to the same bias current increases. As described above, the primary transfer bias is controlled so that the primary transfer bias increases with an increase in the photoconductor running distance, so that the residual charges are removed to suppress the generation of a residual image while an increase in the size and cost of the apparatus is prevented.

In the present embodiment, a voltage value applied to the primary transfer bias roller 45 using the transfer bias applier increases as the post-charging photoconductor potential becomes lower (the absolute value becomes larger).

As described above, when the post-charging potential of the photoconductor 3 is high (the absolute value is small), the influence of the bias current tends to be larger than when the post-charging potential is low. Therefore, as the post-charging photoconductor potential becomes higher, a voltage to be applied to the primary transfer bias roller 45 is decreased, so that the generation of the bias current is restricted to suppress the generation of a residual image.

As described above, in step S105, the surface potential after charging before the exposure by the optical writing unit 20 is measured, so that the optimum transfer bias is selected as illustrated in FIG. 14.

In the present embodiment, the current sensing circuit 42 measures the belt resistance value of the intermediate transfer belt 41 when the intermediate transfer belt 41 is replaced.

Due to such a configuration, the primary transfer bias is appropriately set depending on the initial belt resistance value of each intermediate transfer belt 41 without concern about the deterioration of the yield of the intermediate transfer belts 41, so that the residual charges are removed to suppress the generation of a residual image.

In the present embodiment, as illustrated in step S107, the current sensing circuit 42 measures the belt resistance value R of the intermediate transfer belt 41 again when the number of printed sheets becomes equal to or larger than a predetermined amount after the belt resistance value is measured.

Due to such a configuration, the primary transfer bias to be applied to the primary transfer bias roller 45 is appropriately set from a value including the fluctuation of the belt resistance value in a case where the intermediate transfer belt 41 is used for a predetermined running distance, so that the residual charges are removed to suppress the generation of a residual image.

The followings are descriptions of some aspects of the present disclosure.

Initially, a description is given of a first aspect.

The image forming apparatus 100 according to the present embodiment includes the charging roller 23 as a charger to charge a surface of the photoconductor 3 with a charge of a single polarity; the optical writing unit 20 as an exposure device to irradiate the surface of the photoconductor 3 with light after charging by the charging roller 23 to form an electrostatic latent image; the developing device 7 as a developing device to supply a developer to the surface of the photoconductor 3; the primary transfer bias roller 45 as a transferor to transfer an image developed by the developing device 7, from the surface of the photoconductor 3 onto the intermediate transfer belt 41; the drum cleaning device 15 as a cleaner to clean the developer remaining on the surface of the photoconductor 3 after an image transfer by the primary transfer bias rollers 45; the current sensing circuit 42 as a belt resistance sensing device provided for one or more primary transfer bias rollers 45 to detect a resistance value from a current value flowing during application of a transfer bias; and the transfer bias power supply 72 as a transfer bias applier to control, according to the belt resistance value R detected by the current sensing circuit 42, the transfer bias applied to the primary transfer bias roller 45.

Such a configuration removes the residual charges to suppress the generation of a residual image while the configuration prevents an increase in the size and cost of the apparatus due to an electricity removal member.

Next, a description is given of a second aspect.

In the image forming apparatus 100 according to the present embodiment, in addition to the configuration described in the first aspect, the voltage value applied to the primary transfer bias roller 45 using the transfer bias power supply 72 increases as the running distance of the photoconductor 3 increases.

With such a configuration, the primary transfer bias is controlled so that the primary transfer bias increases with an increase in the running distance of the photoconductor, so that the residual charges are removed to suppress the generation of a residual image while an increase in the size and cost of the apparatus is prevented.

Next, a description is given of a third aspect.

In the image forming apparatus 100 according to the present embodiment, in addition to the configuration described in the first or second aspect, the voltage value applied to the primary transfer bias roller 45 using the transfer bias power supply 72 increases as the post-charging potential of the photoconductor 3 is lower.

With such a configuration, as the post-charging photoconductor potential becomes higher, a voltage to be applied to the primary transfer bias roller 45 is decreased, so that the generation of the bias current is restricted to suppress the generation of a residual image.

Next, a description is given of a fourth aspect.

In the image forming apparatus 100 according to the present embodiment, in addition to the configuration described in any one of the first to third aspects, the current sensing circuit 42 measures the belt resistance value R of the intermediate transfer belt 41 when the intermediate transfer belt 41 is replaced.

With such a configuration, the primary transfer bias to be applied to the primary transfer bias roller 45 is appropriately set from a value including the fluctuation of the belt resistance value in a case where the intermediate transfer belt 41 is used for a predetermined running distance, so that the residual charges are removed to suppress the generation of a residual image.

Next, a description is given of a fifth aspect.

In the image forming apparatus 100 according to the present embodiment, in addition to the configuration described in any one of the first to fourth aspects, the current sensing circuit 42 measures the belt resistance value R of the intermediate transfer belt 41 again when the number of printed sheets after the previous measurement of the belt resistance value R is equal to or greater than a predetermined amount.

With such a configuration, the primary transfer bias to be applied to the primary transfer bias roller 45 is appropriately set from a value including the fluctuation of the belt resistance value in a case where the intermediate transfer belt 41 is used for a predetermined running distance, so that the residual charges are removed to suppress the generation of a residual image.

The advantageous effects described in the embodiments of the present disclosure are merely a list of suitable effects generated from the disclosure. The advantageous effects according to the disclosure are not limited to “the advantageous effects described in the embodiments”.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus, comprising:
a photoconductor;
a charger configured to charge a surface of the photoconductor with a charge of a single polarity;
an exposure device configured to irradiate the surface of the photoconductor with light after charging by the charger to form an electrostatic latent image;
a developing device configured to supply a developer to the surface of the photoconductor;
a transferor configured to transfer an image developed by the developing device, from the surface of the photoconductor onto an intermediate transfer belt;
a cleaner configured to clean the developer remaining on the surface of the photoconductor after an image transfer by the transferor;
a belt resistance sensing device provided for the transferor and configured to detect a resistance value from a current value flowing during application of a transfer bias; and
a transfer bias applier configured to control, according to the resistance value detected by the belt resistance sensing device, the transfer bias applied to the transferor.

2. The image forming apparatus according to claim 1,
wherein a voltage value applied to the transferor using the transfer bias applier increases with an increase in a running distance of the photoconductor.

3. The image forming apparatus according to claim 1,
wherein a voltage value applied to the transferor using the transfer bias applier increases as a post-charging potential of the photoconductor is lower.

4. The image forming apparatus according to claim 1,
wherein the belt resistance sensing device measures a resistance value of the intermediate transfer belt when the intermediate transfer belt is replaced.

5. The image forming apparatus according to claim 1,
wherein the belt resistance sensing device measures a resistance value of the intermediate transfer belt again when a number of printed sheets after previous measurement of the resistance value of the intermediate transfer belt is equal to or larger than a predetermined amount.
